(19) United States
(12) Patent Application Publication
(10) Pub. No.: US 2012/0245911 A1
(43) Pub. Date: Sep. 27, 2012

(54) Simulating dynamic reservoir behaviour

(75) Inventors: Kevin Hermansen, Oslo (NO); Eigil Samset, Oslo (NO)

(73) Assignee: KONGSBERG OIL & GAS TECHNOLOGIES AS, Sandvika (NO)

(21) Appl. No.: 13/208,376

(22) Filed: Aug. 12, 2011

Related U.S. Application Data
(60) Provisional application No. 61/373,289, filed on Aug. 13, 2010.

(51) Int. Cl. G06G 7/48

(52) U.S. Cl. 703/10

(57) ABSTRACT

A method for simulating and displaying dynamic reservoir behavior.

### CROSS-REFERENCE TO RELATED APPLICATIONS

This application claims the benefit under 35 USC §119 to U.S. Provisional application 61/373,289 file 13 Aug. 2010.

### FIELD OF THE INVENTION

The present invention relates to simulation of reservoir behavior. More specifically, the invention relates to a method for dynamically simulating a reservoir.

### BACKGROUND OF THE INVENTION

Planning the location of a well is normally done using a ‘guess and test’ approach. Targets are identified based on closure, modelled reserves and likely reservoir properties in the areas. The well is sketched in, and production over the life of the well is modelled with a simulation run on a computer. Limited optimization of the production rate of a given well may be possible, but local optimization of the well location includes too many parameters to be practical. Moving the well in one direction would place the well in another part of the reservoir with potentially different flow properties and quite different behaviour.

A typical ‘simple’ simulation in a small reservoir model will typically take 10's of minutes on a standard PC. In practice this limits the number of iterations a reservoir engineer can perform in terms of adjusting well placement, thus this aspect of planning is normally left to the intuition of an experienced engineer.

New simulation techniques can radically reduce the time taken to model flow, particularly if the physics of the flow are simplified. These techniques could give an indication of the likely effect of a particular well plan in an interactive timeframe. The results will not remove the need to perform a full simulation with the well in place but will aid the well planner in positioning the well prior to running a time consuming simulation. Typical results may be estimated water saturation in the area around the well over the lifetime of the well.

Reservoir simulation is typically a conservative business where results are tested against the most popular software rather than real field results. There is thus a need for a new application for simulator reservoir behavior as an aid to well planning.

The present invention enables to perform efficient interactive well simulation. It will be possible to edit the well path interactively and see the results real time. The results will give a reasonably accurate view of the effects of the well for well planning purposes. A useful measure is the area and location of the reservoir swept by the well after a specific time period given a specific production rate.

Such a tool would represent a step change in the way that wells are planned. Even basic manual iterative optimization of well location is effectively out of reach for most practical purposes, and the interactive simulation according to the present invention will make a huge difference in the planning process. Key benefits would be increased recovery and production optimization.

### SUMMARY OF THE INVENTION

The present invention is a method for simulating dynamic reservoir behavior comprising the steps of:
a) receiving an input defining a small perturbation of an original reservoir simulation model;
b) calculating the effects of said perturbation of said reservoir model;
c) conditionally displaying the effect of the perturbation based on user input selection, and
d) repeating steps a) through c) for dynamically presenting reservoir behaviour over time.

### DETAILED DESCRIPTION OF A GENERAL EMBODIMENT

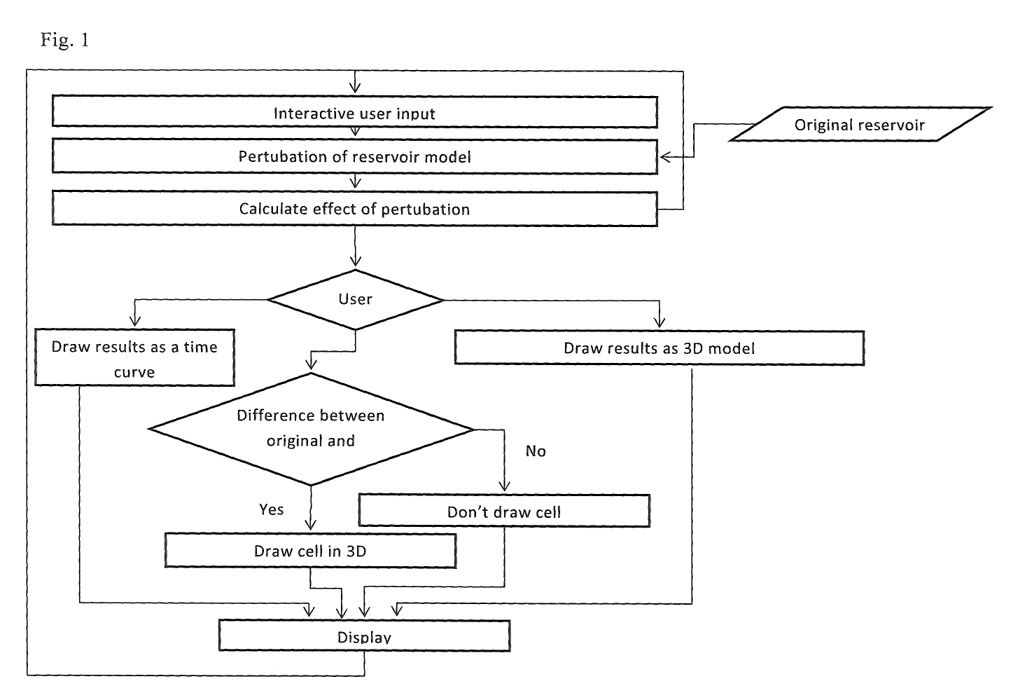

The invention will now be described in more detail with reference to FIG. 1 showing the different steps comprised in the method for simulating dynamic reservoir behavior.

The starting point for the inventive method is an original reservoir model for simulating dynamic reservoir behavior, which has been computed using standard reservoir simulation software.

The first step is to receive an input defining a small perturbation of an original reservoir simulation model.

The second step is to calculate the effects of said perturbation of the reservoir model. This can be done by using methods know to the skilled in the art.

One way is by changing the location of a set of completion cells defined by the well location and it's production area. Another way is by changing the value of one or more properties of a set of cells. Yet another is by changing the grid geometry.

The third step is to display the effect of the perturbation based on user input selection.

In one embodiment, the calculated effect of the perturbation can be displayed as a time curve for a single cell, a collection of cells, or for a production well.

In another embodiment, the calculated effect of the perturbation can be displayed as at least a portion of a three-dimensional reservoir model.

In yet another embodiment a filtering of the cells in the reservoir is first performed for checking whether the difference between the cells in the original and perturbed simulation model is larger than a threshold. If this is the case, only display these cells.

By repeating said three steps the reservoir behaviour will be dynamically displayed as a function of time.

The inventive method enables an operator to perform efficient interactive well simulation in the planning phase for deciding a suitable well location prior to running more a time consuming simulation methods.

1. A method for simulating and displaying dynamic reservoir behavior comprising the steps of:
a) receiving an input defining a small perturbation of an original reservoir simulation model;
b) calculating the effects of said perturbation of said reservoir model;
c) conditionally displaying the effect of the perturbation based on user input selection, and
d) repeating steps a) through c) for dynamically displaying reservoir behaviour over time.

2. The method according to claim 1, wherein the perturbation in calculation step b) is changing the location of a set of completion cells defined by the well location and it's production area.

3. The method according to claim 1, wherein the perturbation in calculation step b) is changing the value of one or more properties of a set of cells.

4. The method according to claim 1, wherein the perturbation in calculation step b) is changing the grid geometry.

5. The method according to claim 1, wherein step c) is performed by displaying the calculated effects as a time curve for a single cell, a collection of cells, or for a production well.

6. The method according to claim 1, wherein step c) is performed by displaying at least a portion of a three-dimensional reservoir model.

7. The method according to claim 1, wherein step c) is performed by first filtering the cells in the reservoir model by checking whether the difference between the cells in the original and perturbed simulation model is larger than a threshold, and only display these cells.

8. A computer-readable storage medium containing executable instructions which, when executed by a processor, perform operations for simulating and displaying dynamic reservoir behavior by performing the method defined in claims 1 to 7.
